(19) United States
(12) Patent Application Publication
(10) Pub. No.: US 2010/0312480 A1
(43) Pub. Date: Dec. 9, 2010

(54) METHOD FOR MONITORING FLUID FLOW IN A MULTI-LAYERED SYSTEM

(76) Inventors: Fredrik Hansteen, Leiden (NL); Paul James Hatchell, Katy, TX (US); Peter Berkeley Wills, (US)

Correspondence Address: SHELL OIL COMPANY, P O BOX 2463, HOUSTON, TX, 772522463, US

(21) Appl. No.: 12/766,498

(22) Filed: Apr. 23, 2010

Related U.S. Application Data
(60) Provisional application No. 61/172,697, filed on Apr. 24, 2009.

(51) Int. Cl. G01V 1/28; G01V 1/40; G06F 19/00

(52) U.S. Cl. 702/12; 702/16

(57) ABSTRACT

A method for monitoring the movement of fluid through a subsurface formation of interest, comprising: a) providing a set of signals obtained by transmitting seismic waves through the formation of interest and receiving signals emanating from the multi-layered system in response to the seismic waves with one or more receivers located a distance from the seismic source(s), b) identifying one or more critically refracted waves among the signals so as to generate a first data set of refracted signals, c) repeating steps a) and b) after a period of time so as to generate a second data set of refracted signals, d) comparing the second data set to the first data set so as to generate a time-lapse data set, e) imaging the time-lapse data set using travel time tomography; and f) inferring information about the movement of fluid based on the image generated in step e).

### RELATED CASES

The present application claims priority from U.S. application Ser. No. 61/172,697, filed on 24 Apr. 2009, which is incorporated herein by reference.

### FIELD OF THE INVENTION

The present invention relates to a method for monitoring a gas flow in a subsurface formation using refracted seismic signals.

### BACKGROUND OF THE INVENTION

Gas and oil reservoirs usually can be found in sedimentary formations, which often include high- and low-velocity layers. Reservoir surveillance can be a key source of information regarding the effect of various operations on the subsurface formations. Depending on the type of information obtained, reservoir surveillance can result in reduced operating costs, reduced impact on the environment, and/or maximized recovery.

Time-lapse seismic methods are known method for monitoring subsurface changes during production. Changes in seismic velocity and density in a reservoir depend on rock type, fluid properties, and the depletion mechanism. In addition, time-lapse seismic responses may be caused by changes in reservoir saturation, pore fluid pressure changes during fluid injection or depletion, fractures, and temperature changes. Areal field monitoring has proven very successful as an aid to understanding the sometimes complex behavior of producing reservoirs. Seismic and other monitoring methods such as passive microseismic monitoring, satellite imagery and material balance calculations can all contribute to an integrated understanding of the reservoir changes.

Surface seismic imaging is one known method for providing a detailed picture of reservoir changes, but there are difficulties associated with the method. In surface seismic imaging methods, data quality can have enormous variations from field to field for various reasons including multiples and reverberations, which can dominate primary energy. Generally, stacking of high fold data is necessary to overcome these problems, but often even stacking may not give a sufficient signal-to-noise-ratio for effective monitoring. Another difficulty with surface seismic monitoring is its high cost, especially on land. To monitor an operation that may extends over approximately tens of square kilometres, e.g. 50 km², with a resolution of approximately tens of meters, e.g. 20 m, requires a huge investment in seismic operations.

“Fold” is a measure of the redundancy of common midpoint seismic data, equal to the number of offset receivers that record a given data point and are added during stacking to produce a single trace. Typical values of fold for modern seismic data range from 1 to 240 for 2D seismic data, and 1 to 500 for 3D seismic data. The higher the fold that is required in order to obtain useful information, the more expensive the system is.

Time lapse refraction seismology has been suggested as an alternative method that might allow measurement of changes in carbonate reservoirs without requiring excessive fold. According to this method, a seismic source is positioned at a point above a reservoir having higher compressional velocity than the surrounding rocks. The seismic source shoots a acoustic signal that forms a critically refracted compressional (CRC) wave along the boundary between the reservoir and the overlying formation. The change in velocity of the head wave on the reservoir fluids and reservoir changes are easily detectable as time shifts in the seismic traces. One drawback of this method was that it required a relatively fast reservoir. Often the reservoir is a relatively slow rock surrounded by faster rocks, so this method cannot be used as it was originally conceived.

Another method comprises transmitting one or more seismic waves through multi-layered system, receiving response signals emanating from the multi-layered system with one or more receivers located a distance from the seismic source; identifying a critically refracted compressional (CRC) waves that has traveled along an interface between a relatively fast layer and an adjacent relatively slow layer, and inferring information about a change in the relatively slow layer based on the CRC wave.

Even with the advent of CRC wave imaging, however, it has been difficult to achieve useful time-lapse seismic monitoring of the movements of subsurface fluids and in particular of injected gases. One difficulty arises out of the need to monitor the over extended periods of time. Another obstacle is the large area that must be monitored. The monitored area needs to be much larger is typically measured using seismic data because subsurface fluid flow tends to be unpredictable. This unpredictability means that injected gas may potentially travel very far from the target area. A third difficulty lies in the fact that target reservoirs for injected gas are often shallow, especially on land. Conventional surface seismic acquisition becomes less efficient and more expensive the shallower the target.

Thus, there is a need to develop a cost-efficient but effective method for monitoring the flow of fluid through a formation underlying a large area.

### SUMMARY OF THE INVENTION

It has been discovered that refracted (CRC) waves can be used to monitor time-lapse shallow gas and geomechanical effects. The signal-to-noise for these waves is usually much larger than for conventional seismic data because they are either first arrivals (CRC waves) so can be reliably used with very low fold.

The present invention includes a method for monitoring the flow of fluids in a subsurface using refracted waves that have passed through the region where the fluid is or may be. In some embodiment, the present method comprises a) providing a set of signals obtained by transmitting one or more seismic waves from one or more seismic sources through the subsurface formation and receiving signals emanating from the subsurface formation in response to the one or more seismic waves with one or more receivers located a distance from the one or more seismic sources; b) selecting one or more critically refracted waves among the received signals so as to generate a first data set of refracted signals, wherein each selected wave has traveled through the subsurface formation of interest; c) repeating steps a) and b) after a period of time so as to generate a second data set of refracted signals; d) comparing the second data set to the first data set so as to generate a time-lapse data set; e) imaging the time-lapse data set using travel time tomography; and f) inferring information about the movement of fluid based on the image generated in step e).

The signals obtained in step a) may be obtained from a plurality of sources arrayed around at least one receiver (or vice versa) such that when a raypath is drawn for each shot/receiver pair, the intersection of the rays with the a plane at a target depth forms a dense areal coverage of an area at the target depth. At least one source may lie farther from the receiver than another source and/or the receivers or sources may lie substantially in a line.

The method may further include between steps d) and e) a step d2) that comprises selecting one or more anomalous data points or seismic traces and excluding them from the time-lapse data set. Step e) may include or be replaced by redatuming the time-lapse data set and/or redatuming the time-lapse data set to each of a plurality of selected depths and selecting at least one of the resulting images.

The monitored fluid may be CO₂ that has been injected into the formation. The receivers and the sources may each be located on or below the earth's surface.

In an alternative embodiment the method may comprise: a) providing a set of signals obtained by transmitting one or more seismic waves from one or more seismic sources through a subsurface formation of interest and receiving signals emanating from the multi-layered system in response to the one or more seismic waves with one or more receivers located a distance from the one or more seismic sources; b) selecting one or more critically refracted waves among the received signals so as to generate a data set of refracted signals, wherein each selected wave has traveled through the subsurface formation of interest; c) redatuming the data set to at least one selected depth so as to obtain a redatumed data set; and d) inferring information about the formation velocity in the subsurface formation of interest by mapping the arrival time of the CRC waves on the redatumed data set; and e) inferring information about the subsurface formation of interest based on the information generated in step d).

### BRIEF DESCRIPTION OF THE DRAWINGS

The present invention is better understood by reading the following description of non-limitative embodiments with reference to the attached drawings, wherein like parts of each of the figures are identified by the same reference characters, and which are briefly described as follows:

FIG. 1 shows a schematic view of a rock model in which the method of the present invention is applied;

FIG. 2 is a graph illustrating reach of refraction imaging from a wellbore;

FIG. 3 is a simplified overhead view of an embodiment of the invention involving multiple wells; and

FIG. 4 is a schematic illustration of one embodiment of an areal distribution of sources and receivers.

In the specification and in the claims, the terms “relatively fast” and “faster” refer to a rock layer having a seismic velocity that is faster than that of another rock layer and the terms “relatively slow” and “slower” are used to describe a rock layer with a seismic velocity that is slower than the seismic velocity of another rock layer.

The phrase “critically refracted wave” is used to describe a seismic wave traveling through a multi-layered system that contains at least one relatively slow and at least one relatively fast layer. A “critically refracted wave” may be a compressional wave or a shear wave, and includes wave types referred to as head waves, diving waves, and/or refracted waves. A critically refracted compressional (CRC) wave is often a first arrival wave, as it travels a greater portion of its path through rocks of higher seismic velocities.

As used herein, the phrase “dense areal coverage” means a collection of points arrayed in a plane such that there are no holes larger than a specified maximum area. The points may be arrayed in a regular or irregular grid, or in another configuration.

The term “first arrival” is used to describe the first seismic event recorded on a seismogram. The term “total depth” is used to describe the maximum depth reached in a well. The term “surface” refers to the earth's surface and in marine applications to the seafloor.

As used herein with respect to data sets, the term “comparing” includes but is not limited to differencing, or subtraction, with or without cross-equalization.

Throughout the present disclosure, it will be understood that concepts disclosed with respect to shots and receivers may be equally effective if the positions are reversed.

### DETAILED DESCRIPTION

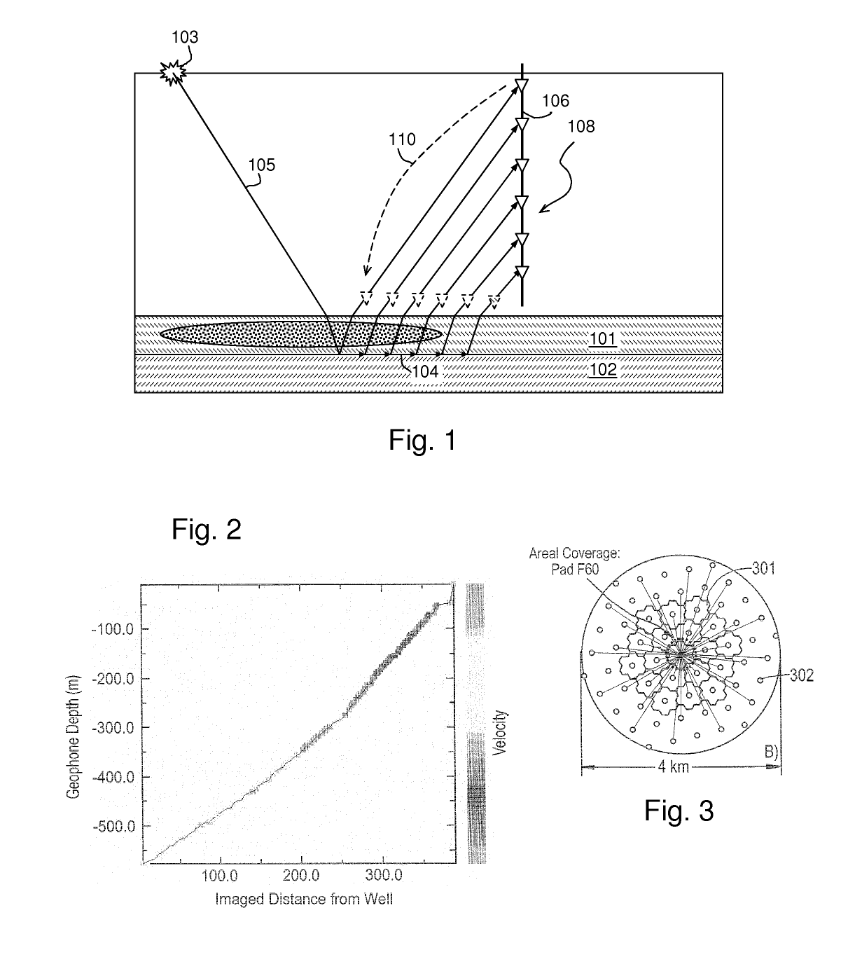

In FIG. 1, a simple rock model 100 that represents the geology of many oil fields includes a slow layer (reservoir layer) 101 is shown with an underlying faster layer (refracting layer) 102, both of which lie beneath an overburden 109. This configuration is only one example of a particular rock model. The fast layer does not need to be immediately below the slow layer. It could, for example, be situated significantly deeper in the earth. It will be understood that the concepts disclosed herein are applicable to other subsurface systems. By way of example only, some subsurface systems result in waves, sometimes referred to as “diving waves,” which have a continuously decreasing velocity and change direction continuously until they eventually turn around.

When an active or passive seismic source 103 is excited, the CRC wave 105 travels through the formation. A portion 104 of the wave travels along the interface between fast layer 102 and slow layer 101 and exits at some lateral position that is related to the relative velocities of the reservoir and underlying fast layer 102. In the situation where the fast layer does not lie directly beneath the slow layer, the CRC wave travels along an interface between the fast layer and the adjacent layer above the fast layer. A geophone array 108 placed in a monitoring well 106 measures the received signals.

In an embodiment in which a surface seismic source shoots into a buried vertical array of geophones, as illustrated in FIG. 1, it is preferred that source be far enough from the geophones that the CRC wave has a viable propagation path. A fine lateral sampling of the reservoir can be obtained by choosing a correspondingly fine sampling of the receiver array in the well. The maximum distance imaged from a particular well is fixed by the critical angle and the vertical extent of the geophone array.

FIG. 2 illustrates the imaged distance from the wellbore plotted against depth of the geophone. The plot shows that deeper geophones, nearer the refracting formation, will image reservoir changes close to the wellbore, while shallower geophones will image points farther from the wellbore. By way of example only, a predicted “reach” for a real field with reservoir depth of approximately 550 meters, a carbonate underlying sandstone, based on ray tracing through a well log model, is approximately 400 meters, as shown in FIG. 2. If this acquisition is performed in a time-lapse mode it allows a measurement of gas flow or other subsurface change along the 2D section fixed by the source and well positions. The result is, for a single shot and a receiver array in a vertical well, a single line of time-shift measurements emanating (in plan view) from the well. In another example, with surface sources and a line of receivers at the surface, the time-shift measurements obtained from a single source would be along a line parallel to the receiver array.

In another embodiment of the invention, the sources may be distributed in an areal fashion. FIG. 3 schematically illustrates the up-scaling of the single well monitoring to an entire field. The hexagons 301 in the picture represent a single “unit” of production wells and the dots 302 are the positions of vertical wells containing geophone arrays. The distance between neighboring units 301 is, in this example, approximately 500 meters and this distance can be considered as the repetition length of the well patterns. Continuing the previous example, which included a radial reach of approximately 400 meters for a given well, if there were a vertical geophone array in every unit, the imaged areas would overlap if there were a dense enough set of sources.

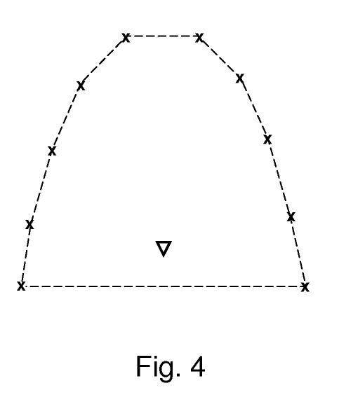

It will be understood that a preferred geometry for a given area may depend on the size, shape, and location of the expected target area and features and obstacles at the surface. In addition, the minimum number of shot/receiver pairs required to generate meaningful data may be determined by using a geometry in which a plurality of sources is arrayed around at least one receiver (or vice versa) such that when a raypath is drawn for each shot/receiver pair, the intersection of the raypaths with a plane at a target depth forms a dense areal coverage of an area at the target depth. In some embodiments, the sources (or receivers) on the surface may be arranged substantially along an elliptical line that encloses one or more receivers (or sources), as shown in FIG. 4.

Referring again to FIG. 3, CRC sources could be placed at or in the vertical monitor wells 302. Alternatively or in addition, permanently installed sources operating continuously could be used to give updates on subsurface fluid flow. In a preferred embodiment, the sources are placed permanently near total depth in the vertical monitor wells and recorded into all geophone arrays within range, providing areal field monitoring for the entire field at an incremental cost well below the typical cost for conventional surface seismic monitoring. The down-hole deployment of sources would remove a significant source of noise remaining for this method, namely near surface statics, allowing subsurface monitoring using refraction arrival that are uncorrupted by surface waves or multiples.

By way of example only, vertical monitor wells 302 may be instrumented with geophone strings having a sampling of approximately 10-20 meters and extending from near the reservoir to the surface. As each vertical monitor well 302 is drilled, one or more sources may be installed near total depth, or provisions may be made for other surface or downhole sources. Suitable sources include but are not limited to: thumper or boomer units, explosives, vibroseis units, vibrators or airguns. During the life of the field, the resulting seismic data will provide an image of subsurface fluid flow with areal coverage and good lateral resolution. Some idea of vertical steam conformance can also be obtained from magnitudes of time shifts and the use of permanent, continuous sources can make this technique of very high resolution in time.

In another embodiment, alternatives to buried sources may be used to reduce the harmful effects of statics time shifts. For example, in the areal monitoring with vertical wells example, statics may be corrected by demanding that the time-lapse time shifts agree for all of the raypaths associated with one receiver well at the geophone at the bottom of the well. For a multi-well setup where the reservoir is changing on both shot and receiver side, the method could employ simultaneously solving for shot and receiver side time shifts over the whole field.

Because deep geophones are expensive, it is desirable to numerically continue the surface wavefield down to the reservoir level. This can be accomplished utilizing a Fourier domain, high angle downward continuation applied in a time migration sense. Many algorithms exist for this operation, usually referred to as redatuming, and any known method of migration may also be used. Redatuming is illustrated conceptually at 110 in FIG. 1. The result of the continuation is excellent, at least for kinematics, and this is the preferred method for interpreting the data. In addition to improving the signal to noise ratio, the downward continuation also improves resolution, in a similar way to migration.

Thus, for the surface geometry, downward continued refraction seismic data, because of its first arrival status, provides a suitable method for imaging subsurface velocity changes with much less noise than reflection surface seismic data. This difference in noise content may even make surface acquisition of refraction data superior to conventional seismic data in challenging geological conditions. Redatuming of data from something other than a dense receiver array is complex, however, and is not physically justified unless a subsequent or preceding summation over a polygon or array of shots is also performed.

Some preferred embodiments of the invention include iterative redatuming, in which the data, or the shots and the data, are redatumed to each of several depths. This yields a series of images of varying interpretability, from which a most preferred image can be selected. In addition, it is possible to infer information about the formation velocity in a region of interest by comparing one or more redatumed data sets to each other or to the original data set.

In some situations, the presence of deeper, faster refractors below the reservoir may affect the method. While these deeper refraction events may eventually cross the refraction due to the interface lying directly beneath the reservoir, these deeper events, when downward continued, will put the same time shift as the refractor underlying the reservoir at the same place. A cross-correlation program computing time shifts will not distinguish between the two deeper faster layers and will give the same time shift for two layers as it would if only one layer were present. This is another very good reason for including downward continuation in the processing flow.

Thus, preferred embodiments of the invention include a method for monitoring the flow of fluids in a subsurface using refracted waves that have passed through the region where the fluid is or may be. In some embodiments, the present method comprises selecting one or more critically refracted waves from a set of received signals so as to generate a first data set of refracted signals, wherein each selected wave has traveled through the subsurface formation of interest. By selecting a second set of refracted waves from a signal set generated some a period of time after the first, and comparing the second data set to the first data set, it is possible to generate a time-lapse data set. The time-lapse data set can be imaged using travel time tomography and information about the movement of fluid can be inferred from the resulting image.

The signals are preferably obtained from a plurality of sources arrayed around at least one receiver (or vice versa) such that when a raypath is drawn for each shot/receiver pair, the intersection of the raypaths with a plane at a target depth forms a dense areal coverage of an area at the target depth. At least one source may lie farther from the receiver than another source (or vice versa) and the receivers or sources may lie substantially in a line.

The method preferably includes selecting one or more anomalous data points or seismic traces and excluding them from the time-lapse data set before imaging it. Preferred embodiments of the method also include redatuming the time-lapse data set at least once and more preferably to each of a plurality of selected depths and selecting at least one of the resulting images.

It has been discovered that the present method yields surprisingly good images of subsurface gas flow over time. For this reason, and because the present method can be used with acquisition geometries that are spatially very sparse, it is believed that the present methods will be well suited to monitoring injected CO₂.

In an alternative embodiment the method may comprise: selecting one or more critically refracted waves from a set of received signals so as to generate a first data set of refracted signals, and redatuming the first data set to at least one selected depth so as to obtain a redatumed data set. Information about the formation velocity in the region of interest can be inferred by comparing the first data set to the redatumed data set, which in turn provides information about the movement of fluid at the selected depth in the formation.

### EXAMPLES

In one exemplary application, CRC waves were modeled using an elastic finite difference modeling package. The elastic wave equation was used in part because much of the propagation modeled was along the sedimentary bed direction and glancing-angle rays were important. The frequency was taken only to 100 Hz in order to save modeling time, although there would be no such constraint in the field data. The earth model was assumed to be layered with the geometry specified above, with the layers being defined by the well logs from a producing oil field. A model was used to simulate change in the formation by lowering the velocity of a localized region while keeping Vp/Vs constant. The grid spacing was 1.5 meters. Compressional velocity was taken as 1900 m/s in the slower layer and Vp/Vs was taken as 2 everywhere in the reservoir. For this simulation, the transition between fast and slow rock was smoothed over 50 meters.

In one simulation, the seismic data were modeled as recorded on the surface, while in a second simulation they were modeled as recorded into a horizontal string just above the reservoir. The deep geometry was superior in that the fluid flow appeared as a kink in the first-arrival wavefield in the second simulation, while the surface geometry of the simulation using surface receivers produced an image that is not immediately interpretable.

Simulations where the distant source shoots into a vertical well have also been analysed and they show effects similar to those measured in the surface geometry. Comparison of synthetics where the receivers are placed in a “horizontal well” at the top of the reservoir have been compared to synthetics where the receivers are placed in a vertical well and they show that downward continuation is again required to optimize spatial resolution. In this case, the operation is more properly referred to as redatuming, with the data in the well redatumed into the “horizontal well” lying just above the reservoir.

### Critically Refracted Compressional (CRC) Waves

The seismic records discussed above also contained critically refracted compressional (CRC) waves. For a receiver gather showing these high S/N arrivals flattened on the direct water arrival we observed refracted arrivals from at least three different sediment layers with different velocities. In a preferred embodiment, the refraction from each layer was isolated by restricting the analysis to the appropriate offset ranges. Next applied was a modified version of the tomographic approach that takes into account the non-horizontal ray-paths assuming flat layers and produces time-lapse velocity difference maps for each of the three successively deeper sediment layers. The shallowest refraction map was very near the seafloor and a rough analysis showed that the refraction depths of the two deepest layers were near 230 and 730 m. While the tomography used only straight rays and did not account for structure, the shallow map appears to be very robust even though the velocity changes are small, on the of order 0.2%. It is important to note that the CRC waves can be recorded in deep water, while, for example, surface waves require the source to be within around 100 m of the seafloor. This means that the CRC measurements are generally more applicable than surface wave measurements.

### DISCUSSION

Advantages of some embodiments of the invention include but are not limited to:
CRC waves are often first arrivals, giving them better signal to noise ratio;
CRC waves are flexible, allowing areal monitoring methods that can have either surface sources and receivers or sources or receivers that are in a borehole or otherwise buried;
CRC waves are usable with low fold acquisition, making the method very cost-effective;
The wavelet in a CRC wave is not corrupted by reverberation noise, making it easy to use for detailed;
CRC waves are synergistic with other seismic methods which may lead to cheap, high resolution and areally extensive field monitoring;

In addition, the method is feasible with straight or deviated wells and may also be applied in an offshore environment using hydrophones instead of geophones. Additionally, the geophones or hydrophones may be placed in different configurations and/or other measurement methods may be used as alternatives. Likewise, it will be understood that the computational steps included in the present method are preferably carried out on a processor.

Those of skill in the art will appreciate that many modifications and variations are possible in terms of the disclosed embodiments, configurations, materials, and methods without departing from their scope. Accordingly, the scope of the claims appended hereafter and their functional equivalents should not be limited by particular embodiments described and illustrated herein, as these are merely exemplary in nature and elements described separately may be optionally combined.

1. A method for monitoring the movement of fluid through a subsurface formation of interest, the method comprising:
a) providing a set of signals obtained by:
i) transmitting one or more seismic waves from one or more seismic sources through the subsurface formation;
ii) receiving signals emanating from the subsurface formation in response to the one or more seismic waves with one or more receivers located a distance from the one or more seismic sources;
b) selecting one or more critically refracted waves among the received signals so as to generate a first data set of refracted signals, wherein each selected wave has traveled through the subsurface formation of interest;
c) repeating steps a) and b) after a period of time so as to generate a second data set of refracted signals;
d) on a processor, comparing the second data set to the first data set so as to generate a time-lapse data set;
e) imaging the time-lapse data set using travel time tomography and outputting the image; and
f) inferring information about the subsurface formation based on the image generated in step e).

2. The method according to claim 1 where the signals obtained in step a) are obtained from a plurality of sources arrayed around at least one receiver or plurality of receivers arrayed around at least one source such that when a raypath is drawn for each shot/receiver pair, the intersection of the raypaths with a plane at a target depth forms a dense areal coverage of an area at the target depth.

3. The method of claim 2 wherein at least one source lies farther from the receiver than another source.

4. The method of claim 2 wherein the receivers lie substantially in a line.

5. The method according to claim 1, further including between steps d) and e) a step d2) that comprises selecting one or more anomalous data points or seismic traces and excluding them from the time-lapse data set.

6. The method according to claim 1 wherein step e) includes redatuming the time-lapse data set.

7. The method according to claim 1, further including redatuming the first and second data sets before step d).

8. The method according to claim 4 wherein step e) includes redatuming the time-lapse data set to each of a plurality of selected depths and selecting at least one of the resulting images.

9. The method according to claim 1 wherein the fluid is CO₂ that has been injected into the formation.

10. The method according to claim 1 wherein the one or more receivers are located on the surface.

11. The method according to claim 1 wherein the one or more seismic sources are located on the surface.

12. The method according to claim 1 wherein the one or more receivers are located beneath the surface.

13. The method according to claim 1 wherein the one or more seismic sources are located beneath the surface.

14. A method for monitoring the movement of fluid through a subsurface formation of interest, the method comprising:
a) providing a set of signals obtained by:
i) transmitting one or more seismic waves from one or more seismic sources through the subsurface formation of interest;
ii) receiving signals emanating from the multi-layered system in response to the one or more seismic waves with one or more receivers located a distance from the one or more seismic sources;
b) selecting one or more critically refracted waves among the received signals so as to generate a data set of refracted signals, wherein each selected wave has traveled through the subsurface formation of interest;
c) on a processor, redatuming the data set to at least one selected depth so as to obtain a redatumed data set and outputting the redatumed data set;
d) inferring information about the formation velocity in the subsurface formation of interest by mapping the arrival time of the CRC waves on the redatumed data set; and
e) inferring information about the subsurface formation of interest based on the information generated in step d).

15. The method according to claim 14 where the signals obtained in step a) are obtained from a plurality of sources arrayed around at least one receiver such that when a raypath is drawn for each shot/receiver pair, the intersection of the rays with the a plane at a target depth forms a dense areal coverage of an area at the target depth.

16. The method of claim 15 wherein at least one source lies farther from the receiver than another source.

17. The method of claim 15 wherein the receivers lie substantially in a line.
